(19) United States
(12) Patent Application Publication
(10) Pub. No.: US 2026/0063158 A1
(43) Pub. Date: Mar. 5, 2026

(54) Methods, Systems, and Apparatus for Mounting and Attaching a Device to a Surface

(71) Applicant: Snap One, LLC, Lehi, UT (US)

(72) Inventors: Brandt Clawson, Corbett, OR (US); Brydon Foster, Vancouver, WA (US); Casey Elstad, Oregon City, OR (US)

(73) Assignee: Snap One, LLC, Lehi, UT (US)

(21) Appl. No.: 19/317,571

(22) Filed: Sep. 3, 2025

Related U.S. Application Data
(60) Provisional application No. 63/689,942, filed on Sep. 3, 2024.

(51) Int. Cl. F16B 13/08; H04R 1/02

(52) U.S. Cl. CPC F16B 13/0808; H04R 1/026

(57) ABSTRACT

A corner mounting assembly unit is described. The corner mounting assembly unit includes a mounting frame including at least: (1) a mounting guide shell formed as one unit and having at least two windows on opposing faces and a top opening on a face perpendicular to the two opposing faces, (2) a top plate, and (3) a back plate; and a retainer having a retention part providing retaining force a more than one position allowed for by the mounting guide shell, the retainer including at least: (1) a screw, (2) a retaining clip, (3) a toggle leg, (4) a spring, and (5) a pivot.

### CROSS-REFERENCE TO RELATED APPLICATION(S)

This application claims priority to and the benefit of U.S. Provisional Patent Application No. 63/689,942, filed Sep. 3, 2024, the contents of which are incorporated herein by reference in its entirety.

### TECHNICAL FIELD OF THE DISCLOSURE

The present disclosure relates generally to mechanical devices, mechanical and/or hardware elements, hardware assemblies, and/or methods for attaching objects to surfaces. According to some embodiments, the present disclosure relates to apparatuses, systems, and methods for mounting and/or attaching an object to a structural surface.

### BACKGROUND OF THE DISCLOSURE

Objects and fixtures, for example, including electronic devices such as audio/video equipment, may be mounted (e.g., fixed, attached, fastened, etc.) to a surface, such as a wall and/or a ceiling. Hardware (e.g., infrastructure hardware, apparatus, parts, components, elements, etc.) for attaching objects secures (e.g., attaches) an object (e.g., a fixture, such as a speaker, a display, a fan, lighting, cabinetry, furniture, art, etc.) to a surface (e.g., a wall, a ceiling, a roof, a floor, a board, etc.). For example, a toggle bolt (for example, which may also be referred to as any of a toggle leg, a butterfly anchor, a toggle anchor, a dry wall anchor, a dogleg, a dogleg anchor, etc.), or any other similar anchoring and/or fastening hardware, may be used to mount objects and/or fixtures to surfaces.

However, numerous challenges, problems, considerations, etc., are encountered when mounting objects to surfaces. In a case of a conventional manner of mounting a speaker (e.g., using a conventional dogleg type or similar (conventional) mounting hardware), a person installing (e.g., mounting, attaching, etc.) a speaker in a wall can encounter a number of problems (e.g. obstacles, considerations, etc.), for example, ranging from speaker mounting configuration and location to surface material and manpower requirements. In this regard, conventional butterfly or toggle anchors and/or other similar conventional type mounting hardware are subject to problems, challenges, and obstacles, such as: (1) balancing a speaker in a position while driving the screw of the mounting hardware; (2) ensuring correct speaker mounting hardware configuration; (3) ease of removing an installed speaker; and (4) rigidity and positioning of anchor and/or other hardware elements and/or speaker components.

### SUMMARY OF THE DISCLOSURE

According to some embodiments, as discussed herein, the present disclosure relates to a speaker attachment assembly and mounting system that provides an efficient and user-friendly mechanism for installing, adjusting, and removing speakers or other objects from mounting surfaces such as walls and ceilings. In some embodiments, the disclosed assembly addresses the challenges of mounting objects in pre-cut holes, among other technical shortcomings, while providing secure retention and ease of installation without requiring multiple tools or assistance from additional personnel.

In some embodiments, the speaker attachment assembly comprises several key components working in coordination to achieve reliable mounting functionality. In some embodiments, the assembly includes a mounting guide shell that serves as the primary structural framework, incorporating guide windows positioned to accommodate the movement of toggle mechanisms. A top plate and back plate provide structural integrity and interface points for the mounting system, while a specialized screw functions as a toggle drive mechanism. In some embodiments, the assembly further incorporates a retaining clip or ring system, toggle legs that serve as the primary retention mechanism, a spring system for applying necessary forces, and a pivot mechanism around which the toggle legs operate.

In some embodiments, the mounting guide shell represents a central component of the disclosure, designed with a corner configuration that accommodates installation at the intersection of device edges. In some embodiments, the shell incorporates multiple guide windows that are positioned in generally opposing orientations, with one embodiment featuring guide windows disposed approximately orthogonal to each other. In some embodiments, the guide windows accommodate various geometric configurations including square, rectilinear, oblong, triangular, and elliptical shapes, providing flexibility in design while ensuring proper toggle leg operation. The mounting guide shell may be fabricated as a molded element, potentially using injection molding techniques with materials such as polymers, thermoplastics, resins, or polycarbonates.

In some embodiments, the toggle leg mechanism forms a critical aspect of the mounting system, designed to provide secure retention while allowing for controlled deployment and retraction. These toggle legs attach to the screw assembly through a pivot mechanism and are positioned to extend through the guide windows of the mounting shell. The toggle legs are configured to operate between deployed and stowed positions, with the deployed position providing horizontal extension for wall retention and the stowed position allowing for passage through mounting holes. In some embodiments, the toggle legs may be fabricated from suitable weight-bearing materials including metals, alloys, plastics, or wood, with specific embodiments utilizing sheet metal construction.

In some embodiments, the screw component, alternatively referred to as a toggle drive, incorporates multiple functional sections including a head part designed to receive various tools such as screwdrivers, Allen wrenches, socket wrenches, or hex drivers. A neck part provides spacing between the head and threaded sections while preventing over-driving of the toggle legs. The threaded part interfaces with the pivot mechanism to control toggle leg positioning, while an end part may include a break-away feature for enhanced retention within the mounting guide shell.

In some embodiments, the spring system utilizes a torsion spring configuration, potentially implemented as a double torsion spring that spans the width or diameter of the drive screw. This spring mechanism applies the necessary force to maintain toggle leg positioning and may be tuned to keep toggle legs perpendicular to the screw regardless of the mounted object's orientation. The spring incorporates base parts, torsion parts with variable outside diameters corresponding to applied torque, and leg parts that interface with the toggle mechanism.

In some embodiments, the pivot mechanism serves as the rotational center for toggle leg operation, incorporating arms for retention to the toggle legs and shoulders for reducing play in the torsion spring system. The pivot attaches to the screw through a threaded hole configuration that matches the screw threading, allowing for controlled movement along the screw's vertical axis.

In some embodiments, installation procedures according to the disclosure require preparation of an appropriately sized hole in the mounting surface and configuration of toggle legs in an ejected state prior to insertion. In some embodiments, the installation process involves pressing the speaker enclosure entirely into the prepared hole until the baffle edge rests against the wall surface. During insertion, toggle legs fold into the enclosure as it passes through the wall, then automatically eject on the interior side with an audible indication of engagement. Once engaged, the mounting system supports the speaker without external assistance, allowing for final tightening of drive screws to secure the installation.

In some embodiments, the disclosure provides for straightforward removal procedures involving counterclockwise rotation of drive screws to move toggle legs toward the enclosure back until they contact the corner window edge. Continued rotation causes toggle legs to fold into the enclosure due to the molded corner cup geometry, with the drive screw ejecting slightly from the baffle edge. In some embodiments, the removal process requires applying pressure to maintain baffle contact with the wall during toggle leg folding, ultimately allowing the toggle legs to disengage from the screw threads and permit free screw rotation without affecting toggle position.

In some embodiments, adjustment capabilities include toolless modification options where toggle legs may be manually folded into the box corner and rotated until ejecting through alternate windows, providing installation flexibility without requiring additional tools or hardware modifications.

In some embodiments, the mounting system specifications accommodate significant load requirements, with embodiments supporting up to thirty-five pounds of vertical load per fastener for through-panel installations in drywall or equivalent substrates. System requirements include minimum clearances between wall studs and the external box sides, wall thickness parameters ranging from three-eighths inch minimum to one and one-half inch maximum, and specific screw head diameter requirements. Toggle leg specifications include sheet metal construction with specific dimensional and material requirements for optimal performance.

Accordingly, as discussed herein, in some embodiments, the disclosure can extend beyond speaker applications to encompass mounting of various objects including display screens and other devices requiring secure wall or ceiling installation. In some embodiments, the modular design approach allows for different back plate configurations to interface with various mounting guide shell types, providing versatility across multiple product categories while maintaining consistent mounting functionality and user experience.

### BRIEF DESCRIPTION OF DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a diagram illustrating a speaker attachment assembly, according to embodiments of the present disclosure;

FIG. 2A is a diagram illustrating views of a (e.g., corner, angled, multi-sided, etc.) mounting guide shell of a speaker attachment assembly, according to embodiments of the present disclosure;

FIG. 2B is a diagram illustrating further views of a (e.g., corner, angled, multi-sided, etc.) mounting guide shell of a speaker attachment assembly, according to embodiments of the present disclosure;

FIG. 3 is a diagram illustrating a screw and a toggle of a speaker attachment assembly, according to embodiments of the present disclosure;

FIG. 4 is a diagram illustrating views of a toggle of a speaker attachment assembly, according to embodiments of the present disclosure;

FIG. 5A and FIG. 5B are diagrams illustrating views of a screw of a speaker attachment assembly, according to embodiments of the present disclosure;

FIG. 6A is a diagram illustrating views of a spring and a pivot, according to embodiments of the present disclosure;

FIG. 6B is a diagram illustrating further views of a spring, according to embodiments of the present disclosure;

FIG. 6C is a diagram illustrating further views of a pivot, according to embodiments of the present disclosure;

FIG. 7 is a diagram illustrating views of a speaker attachment assembly, according to embodiments of the present disclosure;

FIG. 8A is a diagram illustrating views of a device having a speaker attachment assembly, according to embodiments of the present disclosure;

FIG. 8B is a diagram illustrating further views of a device having a speaker attachment assembly, according to embodiments of the present disclosure;

FIG. 9A is a diagram illustrating views of a speaker having a speaker attachment assembly, according to embodiments of the present disclosure;

FIG. 9B is a diagram illustrating further views of a speaker having a speaker attachment assembly, according to embodiments of the present disclosure; and

FIG. 10 is a diagram illustrating a display screen mounting assembly, according to embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

Certain embodiments and principles will be discussed in more detail with reference to the figures.

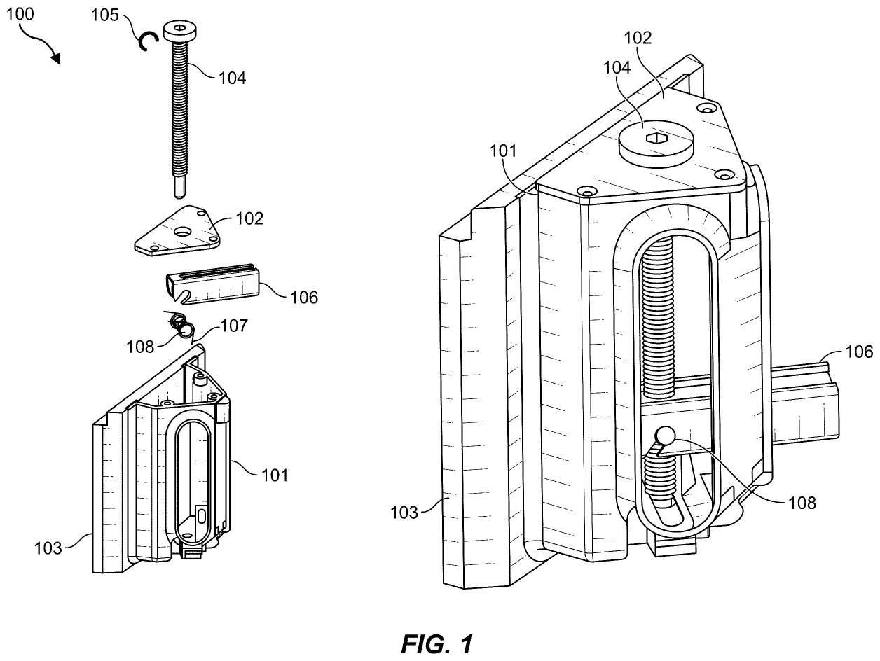

FIG. 1 is a diagram illustrating a speaker attachment assembly, according to embodiments

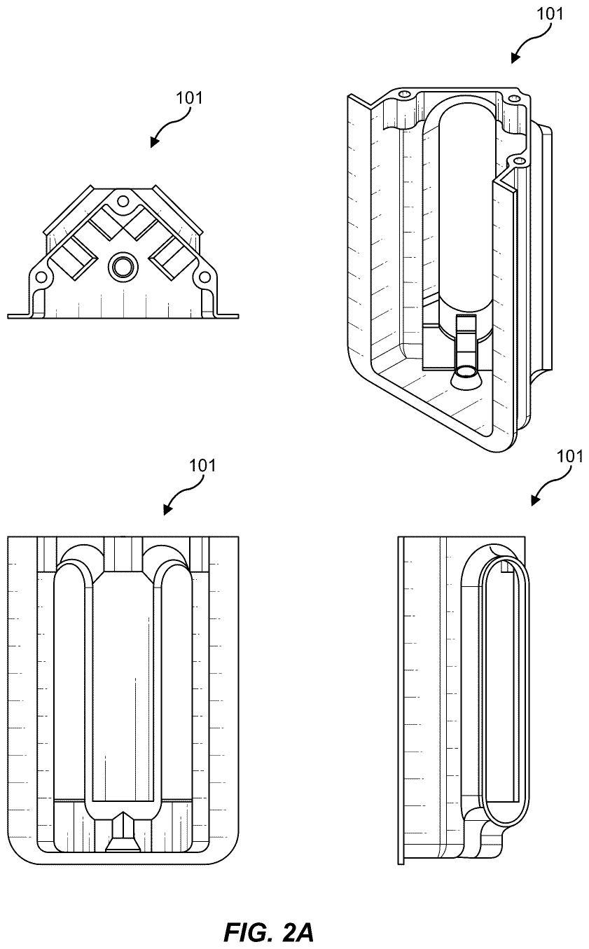

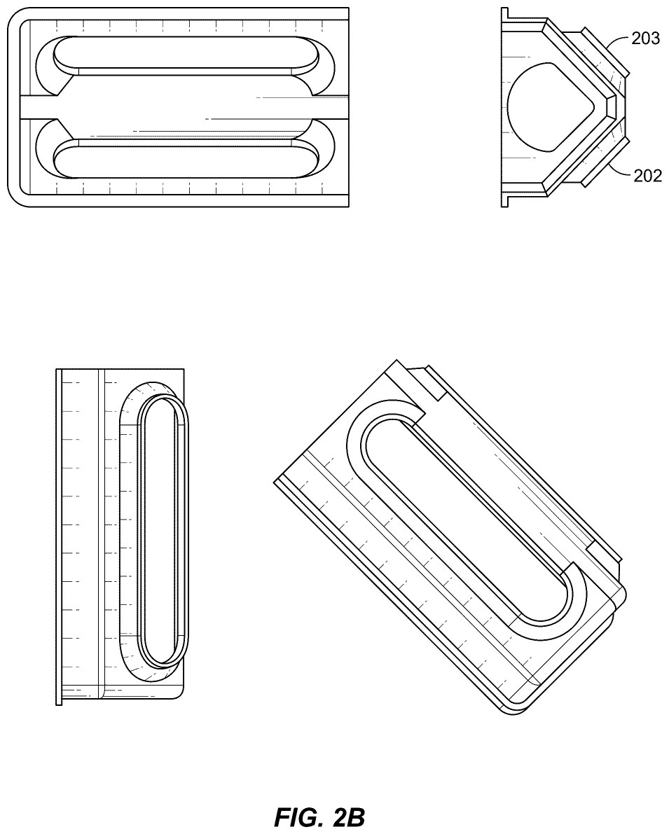

According to embodiments, referring to FIG. 1, a speaker attachment assembly 100 may include any of a mounting guide shell 101, a top plate 102, a back plate 103, a screw 104, a retaining clip (which may be interchangeably referred to as any of a retaining ring, a ring, and a clip) 105, a toggle leg 106, a spring 107, a pivot 108. According to embodiments, referring to FIG. 1, a speaker attachment assembly 100 may be considered to have at least two segments (e.g., components, sections, groups, groups of parts or elements, etc.). For example, such speaker attachment assembly may have a first segment that is a mounting frame and a second segment that is a retainer. According to embodiments any of a mounting guide shell 101, a back plate 103, and a top plate 102 may have (e.g., use, take on) any suitable geometry. That is, although FIG. 1 and subsequent FIG. 2A through FIG. 9B show (e.g., particular) configurations of a speaker attachment assembly and components thereof, the embodiments discussed hereinbelow are not limited to such depicted shapes, positions, dimensions, characteristics, configurations, etc.

According to embodiments, an assembly unit for mounting an object, such as a speaker, may allow (e.g., provide, be used, etc.) for any of mounting (e.g., installation), adjustment, and removal of the object, for example, using a tool (e.g., a screwdriver, a hex wrench, etc.) operated by a person (e.g., having no additional assistance). According to embodiments, in a case where a hole for receiving the object is made in the mounting surface, installation may be accomplished with a single tool (e.g., hex driver) and may be performed by a (e.g., single) person, for example, with no assistance. In this regard, according to embodiments, in a case of an object having an assembly unit for mounting, the assembly unit may be disposed in (e.g., attached to) a corner (e.g., a corner cup) of a box and/or baffle (e.g., baffle of the object) that is to be inserted into a wall. According to embodiments, a spring-loaded toggle may fold into the box during travel through the wall and may eject (e.g., automatically) when it (e.g., sufficiently) clears the inside of the wall.

According to embodiments, prior to installation of an object onto a surface (e.g., into a wall and/or ceiling), the following conditions may (e.g., should, need to be, etc.) be present: (1) an appropriately sized hole in the surface (e.g., to receive the object); (2) one or more corner mounting guide assembly units included in the object (e.g., at the corner of the objects baffling); (3) toggle legs in an ejected state, for example, protruding from a speaker enclosure. According to embodiments, a toggle leg may be put into (e.g., configured to be in) an ejected state, for example, by screwing in the drive screw (e.g., slightly) until the leg is resting on the bottom of the corner window. According to embodiments, with the toggle legs in an ejected state, the object (e.g., the speaker enclosure) may be pressed (e.g., entirely) into the hole, for example, such that the overhanging edge of the baffle is resting on the wall.

According to embodiments, in a case of the baffle resting on the wall, toggle legs may fold up into the enclosure, for example, as the enclosure passes through the wall. According to embodiments, there may be an audible click, for example, when toggle legs eject on the inside of the wall. According to embodiments, in a case where toggle legs are (e.g., have) ejected on the inside of the wall, the mounting system may be (e.g., considered) engaged, and, for example, the speaker enclosure may hang within the hole in the wall without external support. According to embodiments, in case where the object is hanging without external support, drive screws for the mounting system may be tightened, for example, until the speaker enclosure mounts tightly to the wall, and/or the overhanging baffle is snug against the wall.

According to embodiments, an assembly unit for mounting an object, such as a speaker, may allow (e.g., provide, be used, etc.) removal of the object, for example, according to a method described hereinbelow. According to embodiments, a first step of removing the object may be turning the drive screws counterclockwise, for example, so that toggle legs may travel toward the back of the enclosure, for example, until meeting an edge of the corner window. According to embodiments, a second step of removing the object may be toggle legs folding up into the object (e.g., speaker enclosure). That is, according to embodiments, in a case where toggle legs engage the back edge of the window, toggle legs will begin to fold up into the speaker enclosure, for example, due to the geometry of the molded corner cup. According to embodiments, a (e.g. drive) screw may (e.g., begin to) eject slightly from the edge of the baffle of the speaker enclosure.

According to embodiments, a third step of removing the object may be applying pressure to the object (e.g., the speaker baffle) to hold it (e.g., fully) against the wall while the toggle leg (e.g., fully) folds in. According to embodiments, a fourth step of removing the object may be disengaging of toggle legs. For example, according to embodiments, in a case where toggle legs are (e.g., fully) folded into the object (e.g., the speaker enclosure), for example, such that the object may (e.g., fully and/or freely) move (e.g., pass back through) the wall, the drive through may eject (e.g., slightly) from the baffle, for example, such that it protrudes (e.g., approximately) 0.1″. According to embodiments, in such a case, the toggle leg may run off the ends of the threads of the drive screw and disengage. According to embodiments, a fifth step of removing the object may be allowing the drive screw to freely turn. According to embodiments, for example, in a case where toggle legs have run off the ends of the threads of the drive screw and have disengaged, further turning of the drive screw in the counterclockwise direction will have no effect. That is, in such a case, the screw will turn freely without altering the position of a toggle leg, for example, allowing for powered tools to be used without potential for damaging the mounting system.

According to embodiments, an assembly unit for mounting an object, such as a speaker, may allow (e.g., provide, be used, etc.) adjustment of the object, for example, according to a method described hereinbelow. According to embodiments, there may be a case of toolless adjustment, for example, wherein, prior to installation, toggle legs may be manually folded up into the box corner and rotated until ejecting through a (e.g., other, alternate, etc.) window.

According to embodiments, although not limited thereto, there may be a case of a mounting system as described hereinbelow supporting (e.g., accommodating) up to 35 lbs. of vertical load per fastener (e.g., per mounting guide assembly unit) for a through-panel installation in drywall or other equivalent substrate. According to embodiments, such a case may have any of the following requirements and/or features: (1) a minimum gap between wall studs and the external side of the box being ¾″ on either pair of opposing sides (e.g., top and bottom, or left and right sides); (2) wall features: minimum thickness of ⅜″, and maximum thickness of 1½″; (3) a screw head diameter no larger than 0.75″ and no smaller than 0.5″, for example, formed of mild steel, and in case of a hex drive, having a large rectangular profile head, and (4) a toggle leg formed of sheet metal (e.g., steel) having a ½″ square tube with 0.049″ wall, wherein the metal may be 16 gauge, finished black zinc over tumbled finish.

FIG. 2A is a diagram illustrating views of a (e.g., corner, angled, multi-sided, etc.) mounting guide shell of a speaker attachment assembly, according to embodiments; and FIG. 2B is a diagram illustrating further views of a (e.g., corner, angled, multi-sided, etc.) mounting guide shell of a speaker attachment assembly, according to embodiments.

According to embodiments, referring to FIG. 2A, various views, such as top, bottom, front, back, side, and angled views of a mounting guide shell 101 are shown, for example, for depicting features and elements associated with a mounting guide shell as discussed above. According to embodiments, FIG. 2B is an alternate mounting bracket showing a different physical structure and molding, for example, having any of: a hole in the bottom to terminate a different end of a screw, and a modular version of parts that are molded together.

According to embodiments, referring to FIGS. 2A and 2B, a mounting guide shell 101, which may be interchangeably referred to as a guide shell, a corner guide shell, a mounting guide shell, a corner mounting guide shell, etc., may have any number of guide windows, for example, such as any of guide windows 202 and 203. According to embodiments, a mounting guide shell 101 may be disposed in a corner (e.g., an area wherein two edges meet) of a device (e.g., a speaker, a touchscreen, etc.) to be mounted to a (e.g., vertical and/or horizontal) surface. According to embodiments, any number of guide windows, such as guide windows 202 and 203, may be disposed (e.g., on and/or in the corner mounting guide shell 101) in a manner to be (e.g., generally, approximately, etc.) opposed to each other. For example, according to embodiments, in a case of guide windows 202 and 203, the guide window 202 is disposed (e.g., approximately) orthogonal to the guide window 203. According to embodiments, the guide windows may be formed as any suitable geometry, for example, that allows for toggle leg 106 to extend to all necessary positions for speaker mounting. That is, according to embodiments, guide windows 202 and 203 may be formed as square shapes, rectilinear shapes, oblong shapes, triangular shapes, elliptical shapes, and/or any other similar and/or suitable shape.

According to embodiments, a mounting guide shell 101 may be a molded element. As used herein, the terms “mold,” “molding,” “molded,” etc., may refer to injection molding. For instance, a molded member may be fabricated by injection molding. Some examples of the molded members described herein may be fabricated from a material(s) such as a polymer(s), thermoplastic(s), resin(s), polycarbonate(s), etc. According to embodiments, a mounting guide shell 101 may include a top opening, for example, for accommodating the top plate 102. According to embodiments, a mounting guide shell 101 may formed as one or more molded pieces that attach to a back plate 103. According to embodiments, a mounting guide shell 101 may be any of: molded as one unit, hinged between any adjoining faces, molded having any shape, form, or size of guide windows, for example, while allowing for the toggle leg 106 to extend (e.g., fully, into all necessary or possible positions).

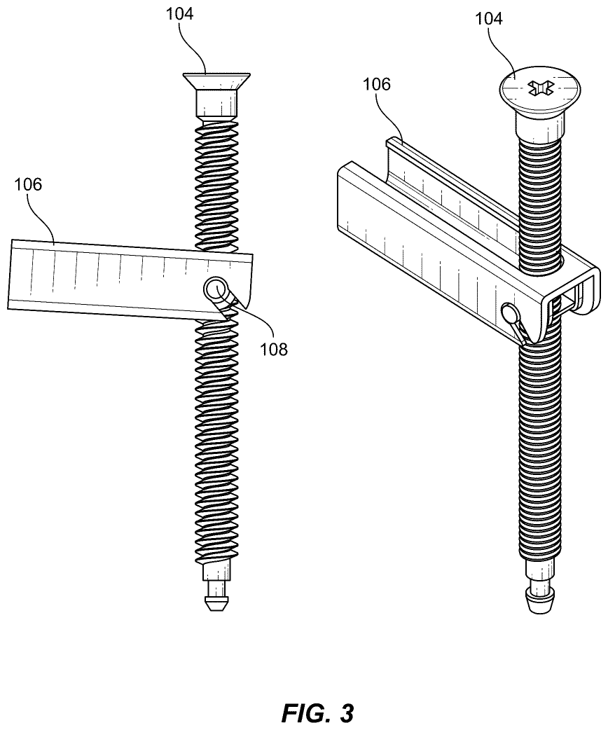

FIG. 3 is a diagram illustrating a screw and a toggle of a speaker attachment assembly, according to embodiments.

According to embodiments, referring to FIG. 3, a toggle leg 106 may be attached to a screw 104, for example, using a pivot 108 that may be attached to the screw 104. According to embodiments, the pivot 108 may be attached to the screw 104 so as to travel along a vertical axis of the screw 104. Referring to FIG. 3, the pivot 108 may have an interior (e.g., circular) surface having threading thereupon, for example, allowing the pivot 108 to be attached while traveling along the screw 104 (e.g., due to rotational forces applied at the threading).

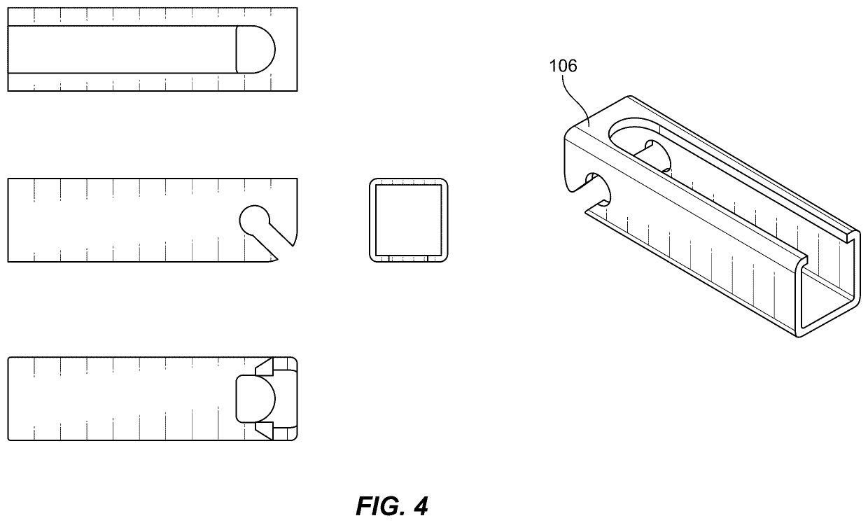

FIG. 4 is a diagram illustrating views of a toggle of a speaker attachment assembly, according to embodiments.

According to embodiments, referring to FIG. 4, various views, such as top, bottom, front, rear, side and angled views, of a toggle 106 are shown, for example, for depicting features and elements associated with a toggle as discussed above.

According to embodiments, for example, referring to FIG. 3 and FIG. 4, a toggle leg 106 may have any suitable shape, such as a rectilinear shape (e.g., as shown in FIG. 4), a circular or ovular shape, a triangular shape, or any other similar and/or suitable shape that is elongated in one direction (e.g., dimension). According to embodiments, a toggle leg 106 may be formed of any suitable material, such as a metal, an alloy, a plastic, wood, or any other material that may be used for weight bearing purposes. The toggle leg 106 may include several features and/or components allowing for: (1) attaching the toggle leg 106 to an element around which the toggle rotates; and (2) overlaying the toggle leg 106 onto the screw 104, for example, for when the toggle leg 106 is in a retracted and/or compacted position (e.g., approximately parallel or aligned along a longitudinal/vertical axis of the screw 104. However, the toggle leg 106 is not limited thereto. That is, according to embodiments, a toggle leg 106 may be formed to have any shape suitable, for example, for retaining the object being mounted in a (e.g., relatively) fixed position.

According to embodiments, the toggle leg 106 may be in a horizontally extended position (e.g., relative to a longitudinal/vertical axis of the screw 104), for example, due to a force allowing (e.g., forcing) the toggle leg 106 to rotate around the pivot 108. According to embodiments, a spring 107 may apply (e.g., be for applying) a force to the toggle leg 106 such that the toggle leg 106 rotates around an axis along which the toggle leg 106 is attached to the pivot 108. According to embodiments, a toggle leg 106 may be (e.g., generally) in or moving between first and second positions, such as a deployed position and a stowed position. That is, a toggle leg 106 may be in any of two (e.g., approximate) positions, such as horizontal or vertical, up or down, in or out, extracted or retracted, etc.

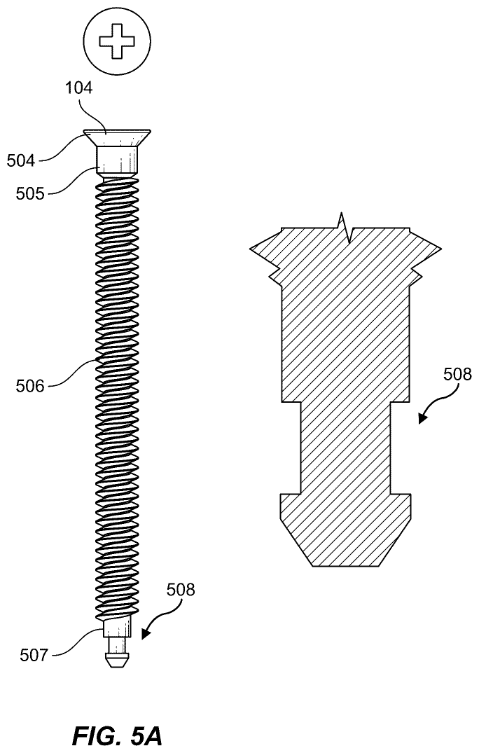

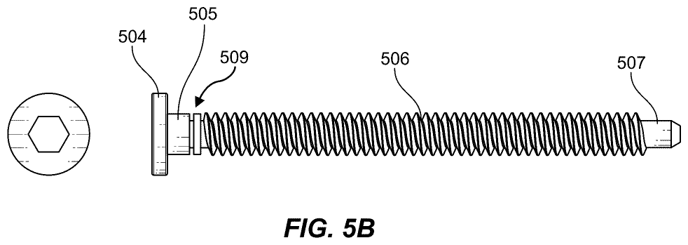

FIG. 5A and FIG. 5B are diagrams illustrating views of a screw of a speaker attachment assembly, according to embodiments.

According to embodiments, a screw 104, for example as shown in FIGS. 5A and 5B, may be referred to as a toggle drive. For example, in a case of the screw 104 of a speaker attachment assembly, as discussed above, the screw 104 may be used to drive the toggle to a certain (e.g., desired, fixed, etc.) position. In such regard, the screw 104 may be (e.g., function as, operate as, etc.) a toggle drive as it drives the toggle to a position.

According to embodiments, referring to FIGS. 5A and 5B, a screw 104 may have any number of parts, areas, sections, elements, components, etc., forming the entirety of the screw 104. For example, according to embodiments, a screw 104 may include any of a head part 504, a neck part 505, a thread part 506, and an end part 507 that may include a break-part 508. Further, according to embodiments, although not required for all embodiments of a screw 104, a retaining ring channel 509 (e.g., for accommodating a retaining ring) may be included in an area of a neck part 505. According to embodiments, a head part 504 of a screw 104 may be for receiving a tool (e.g., a Phillips and/or flat head screwdriver, an Allen wrench, a socket wrench, a star and/or hex nut driver), for driving the screw 104.

According to embodiments, a neck part 505 may provide a gap between the head part 504 and the thread part 506. For example, according to embodiments, the neck part 505 may prevent the toggle leg 106 from travelling (e.g., being driven to) a certain point before the head part 504, thus, for example, avoiding possible damage from over-driving the toggle leg 106. According to embodiments, a thread part 506 may be between an end part 507 and any of a neck part 505 and a head part 504. The end part 507 may include the break-part 508, for example, for allowing retaining of a screw 104 via interaction (e.g., fastening, mating, retaining, etc.) with molded features included in a bottom of a mounting guide shell 101.

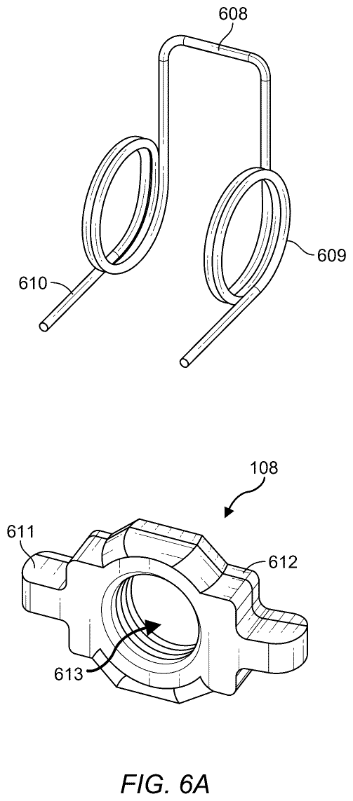

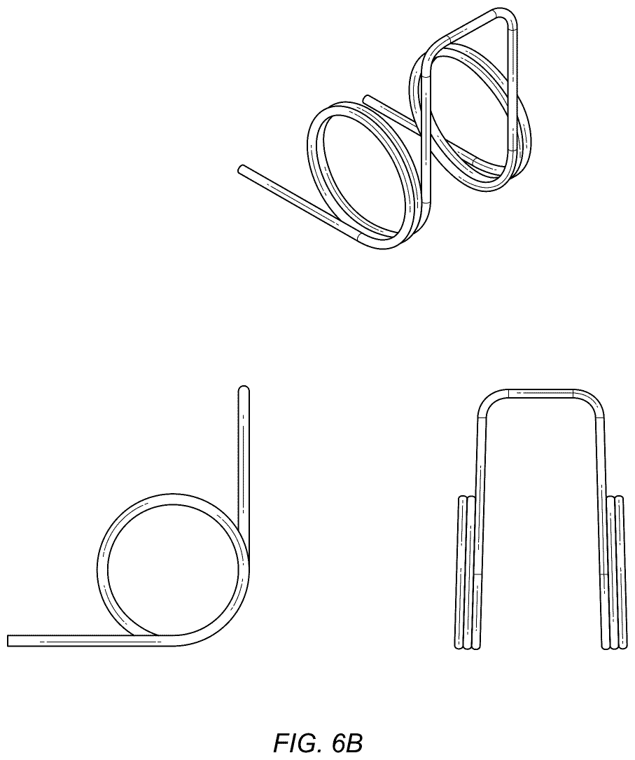

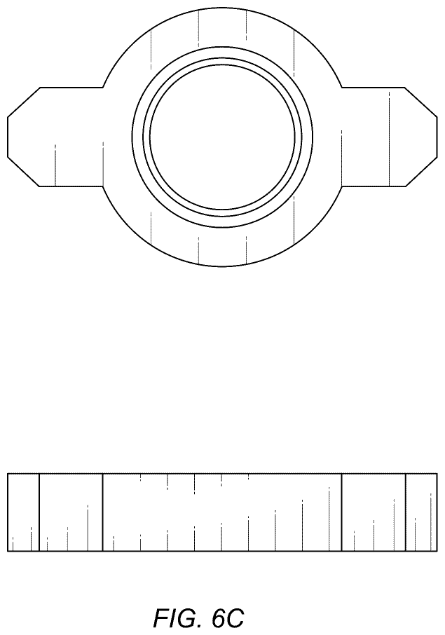

FIG. 6A is a diagram illustrating views of a spring and a pivot, according to embodiments; FIG. 6B is a diagram illustrating further views of a spring, according to embodiments; and FIG. 6C is a diagram illustrating further views of a pivot, according to embodiments.

According to embodiments, referring to FIGS. 6A and 6B, a spring 107 may be a torsion spring (e.g., a double torsion spring) that spans (e.g., a width of, a diameter of, etc.) a (e.g., drive) screw 104. According to embodiments, a spring 107 may be formed of a material (e.g., metal, plastic, etc.) having pliability (e.g., elasticity, flexibility, bendability, etc.) for providing a (e.g., torsion, torque, etc.) force, for example, upon the toggle leg 106. According to embodiments, spring 107 may include any of a base part 608, a torsion part 609, and a leg part 610. For example, as shown in FIGS. 6A and 6B, the spring 107 may include a base part 608, for example, formed as a metal wire, extending in two directions into respective torsion part(s) 609 (e.g., coiled metal wire) that extends into respective (e.g., open) leg part(s) 610. According to embodiments, a torsion part 609 may have a varying outside diameter, for example, that varies according to an amount of torsion (e.g., a torque force) applied to the torsion part 609. According to embodiments, there may be a maximum outside diameter of the torsion part 609, for example, that corresponds to (e.g., that fits, encompasses, surrounds, etc.) an outside diameter of (e.g. oblong shaped mounting) arms 611. According to embodiments, a torsion part 609 (e.g., a spring) may be tuned for maintaining (e.g., tuned such that a torque force maintains) a toggle leg 106 perpendicular to a screw 104, for example, at any angle, regardless of orientation of a speaker (e.g., or other such mounted object). According to embodiments, a base part 608 (e.g., of a double torsion spring) may span a screw 104 (e.g., a width of a part of the screw 104).

According to embodiments, referring to FIGS. 6A and 6C, a pivot 108 may be an element around which a torsional force of a spring 107 occurs. That is, the pivot 108 may be for positioning a toggle leg 106 receiving a torsional force of the spring 107, for example, at a position or location at which the toggle leg 106 may change an attenuation (e.g., from horizontal to vertical attenuation). According to embodiments, a pivot 108 may (e.g., be formed to) attach to a toggle leg 106. For example, referring to FIGS. 6A and 6C, a pivot 108 may have any number of arms 611, for example, for retaining the pivot 108 to a toggle leg 106. According to embodiments, a pivot 108 may have any number of shoulders 612, for example, for reducing play in a torsion spring. That is, in a case of a pivot 108 having more than one shoulder 612, according to embodiments, a width of each of the shoulders may be (e.g., approximately) equal to an internal diameter of the spring, and in such a case, the spring may fit over the shoulder feature and be retained approximately centered around the arm. According to embodiments, a pivot 108 may be mounted to a screw 104, for example, by having a (e.g., tapped, threaded, etc.) hole 613, for example, having a threading matching that of the screw 104.

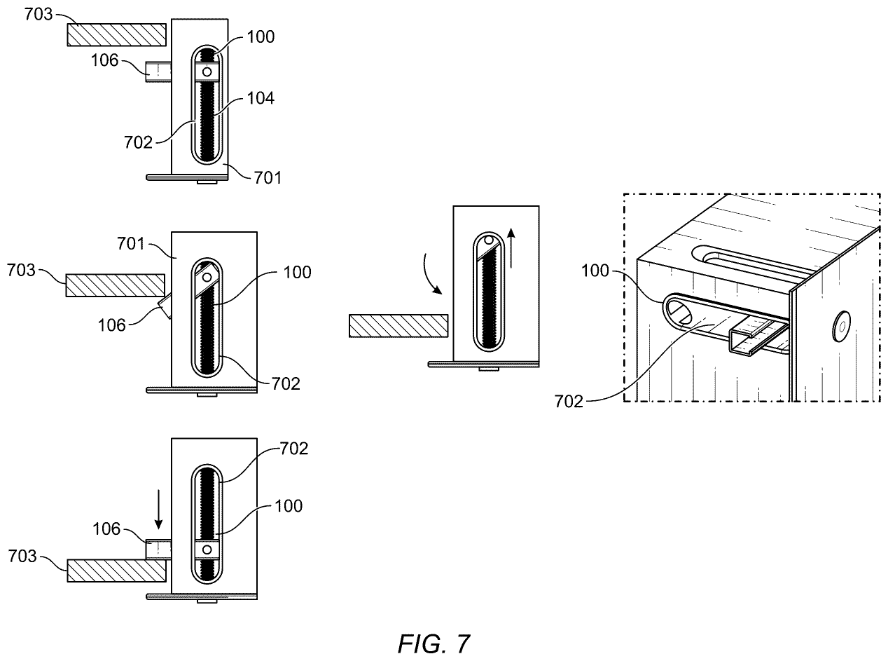

FIG. 7 is a diagram illustrating views of a speaker attachment assembly, according to embodiments.

According to embodiments, referring to FIG. 7, a speaker attachment assembly 100, for example as discussed above, may be disposed in a speaker 701. According to embodiments, the speaker 701 may have one or more windows 702, for example, through which a toggle leg 106 may extend for attaching the speaker 701 to a surface (e.g., a wall) 703.

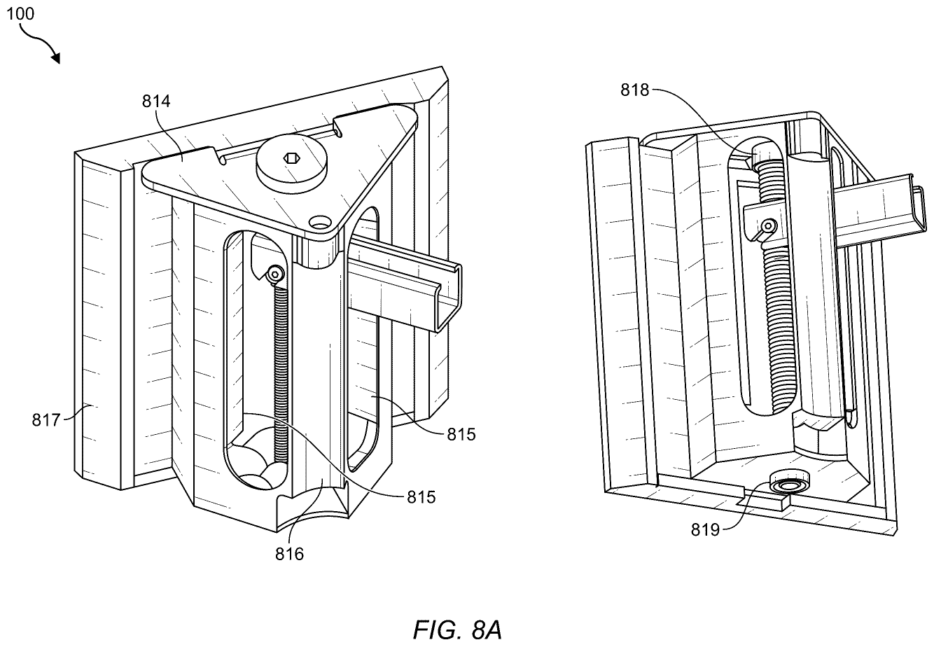

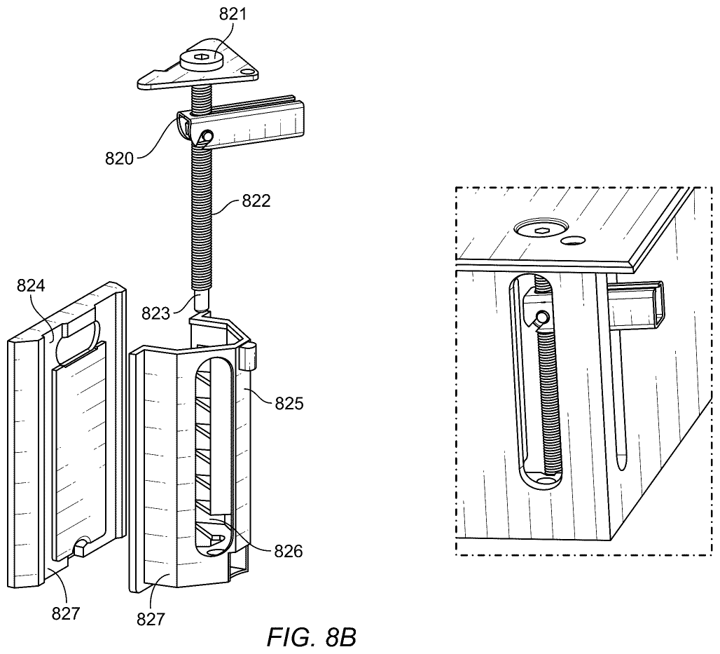

FIG. 8A is a diagram illustrating views of a device having a speaker attachment assembly, according to embodiments; and FIG. 8B is a diagram illustrating further views of a device having a speaker attachment assembly, according to embodiments.

According to embodiments, referring to FIGS. 8A and 8B, a top plate (e.g., top plate 102) may be formed of steel. According to embodiments, a steel top plate feature 814 may allow for more rigidity, for example, for providing (e.g., much) greater torque before failure. According to embodiments, a multiple guide(s) (e.g., multiple guide windows) feature 815 may allow for a toggle (e.g., toggle leg 106, or any similar and/or suitable arm type element) to be rotated between (e.g., two approximately) perpendicular planes. According to embodiments, a curved internal surface feature 816 of a corner mounting guide shell (e.g., corner mounting guide shell 101 may provide a surface, for example, ensuring and/or allowing for a toggle/arm (e.g., toggle leg 106) freely moving between windows 202, 203, and for example, while not getting stuck (e.g., immobilized, trapped, etc.) between guide windows.

According to embodiments, any suitable shape, such as any one or more of curved, trapezoidal, triangular, rectilinear, etc., types of shapes may be used to may provide a surface ensuring a toggle and/or arm (e.g., toggle leg 106) freely moves between windows. According to embodiments, a corner bulkhead feature 817, which may be referred to as an air-sealing bulkhead 817, of a backplate 103 may be for use with an enclosed loudspeaker system. That is, according to embodiments, a corner bulkhead feature 817 may be designed such that that it may serve as an air-sealing bulkhead 817 when integrated with an enclosed loudspeaker system. However, the present disclosure is not limited thereto, and a backplate 103 may (e.g., be designed to) integrate into enclosures of a variety of devices, objects, fixtures, etc.

According to embodiments, a screw retention feature 818 may provide retention of (e.g., driving of) a (e.g., drive) screw. For example, screw retention feature 818 may keep a screw 104 from backing out of a corner mounting guide shell 101. That is, according to embodiments, a screw 104 may have a (e.g., machined) groove, for example, in which retaining clip or ring 105 may be disposed (e.g., is retained), that keeps the screw 104 from (e.g., potentially) backing out of a threaded retainer 819 of a corner mounting guide shell 101. According to embodiments, a molding feature 819, which may be referred to as and/or be an example of a threaded retainer 819, may capture an end of a screw, for example, so that no additional retention hardware is needed. According to embodiments, the retaining clip or ring 105 may block the screw 104 from backing out vertically (e.g., along the screw's long axis). That is, according to embodiments, a retaining feature 818/819 in the corner mounting guide shell 101 may ensure that the end of the screw does not move annularly (i.e., in a horizontal direction), perpendicular to the long axis of the screw 104. According to embodiments, (e.g., optional) break-part 508 may allow for the retaining feature 819 to (e.g., additionally) serve as vertical retention of the screw, for example, additional to (e.g., in place of) retaining ring 105, for example, using integrated molded plastic clips.

According to embodiments, a tube feature 820 of a toggle leg 106 may (e.g., provide) contact a screw, for example, on both sides of a screw 104, to relieve (e.g., practically all) force from a (e.g., central) pivot, such as pivot 108. According to embodiments, a screw head ejection feature 821, for example, of screw 104, may be (e.g., may provide) a visual indication of non-engagement of the screw, for example, by ejecting (e.g., pushing up) a screw 104, for example, by ⅛ of an inch. According to embodiments, the screw head ejection feature 821 may be an interaction between the pivot 108, the screw end 507, and the retention feature 819. That is, according to embodiments, in a case where a pivot 108 runs off the end of screw threads 506, the pivot 108 may meet a retention feature 819 that may allow (e.g., further) turning of the screw 104, for example, while not further driving into an end the mounting guide shell 101, and for example, may eject a head 504 from a surface of the plate 102. In other words, according to embodiments, the head 504 may eject from the surface of the plate 102 because of (e.g., a result of, due to, associated with, etc.) the interaction between the pivot 108, the screw end 507, and the retention feature 819.

According to embodiments, an assembly installation feature 822 may provide installation (e.g., of the assembly unit 100 entirely) from a top of a corner of a corner mounting shell guide 101. For example, allowing the corner mounting guide shell 101 to be (e.g., otherwise completely) enclosed.

According to embodiments, a lead out feature 823 of a screw 104 may be unthreaded, for example, for allowing a toggle leg 106 to cam off the threads, for example, when the toggle leg 106 is (e.g., fully) unscrewed or stowed. According to embodiments, an internal bulkhead (e.g., backplate 103) molding (e.g., machining) feature 824 may allow for a variety of molding shapes, for example, such that the assembly unit 100 interfaces a corner mounting guide shell 101 to a variety of products. According to embodiments, a corner mounting guide shell molding feature 825 may allow for greater usability by being independent of a back plate 103 and the rest of the product in which it is used. According to embodiments, a corner mounting guide shell interior molding feature 826 may allow (e.g., facilitate) (e.g., full, better, increased, etc.) retraction (e.g., folding, stowing, etc.) of a toggle leg 106. According to embodiments, a two-part enclosure feature 827 may provide different types/shapes of back plates 103 to be interfaces different types/shapes of mounting guide shells, for example, for allowing for a greater variety of toggle assembly types, configurations, etc.

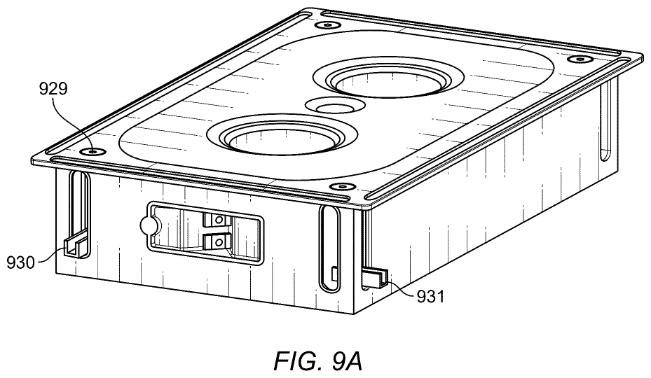

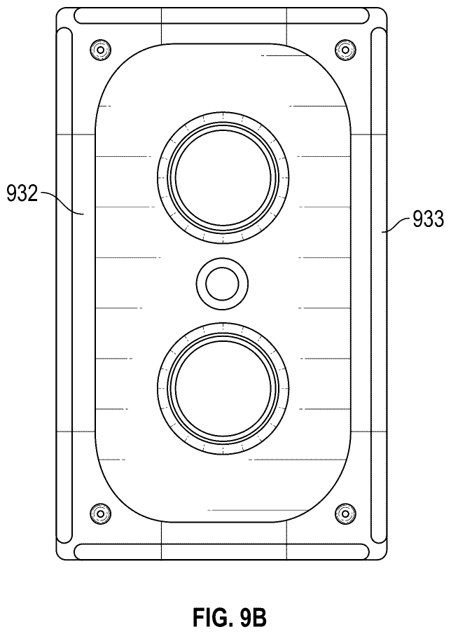

FIG. 9A is a diagram illustrating views of a speaker having a speaker attachment assembly, according to embodiments; and FIG. 9B is a diagram illustrating further views of a speaker having a speaker attachment assembly, according to embodiments.

According to embodiments, a first operating feature 929 may allow for a screw 104 to be: (1) tightened for bringing an edge flange (e.g., of a speaker, TV, etc., flush, adjacent, aligned, etc.) to a surface (e.g., a wall); and (2) (e.g., reverse direction) loosened to fold the toggle leg 106 into a corner cavity of a corner mounting guide shell 101. According to embodiments, a second operating feature 930 may allow for mounting hardware to extend through a corner when spring loaded and to fold-up when pressed through a wall so to spring back into place in a wall cavity of the corner mounting guide shell. According to embodiments, a third operating feature 931 may allow for a toggle leg 106 to be extend out of ends or sides of the object to be mounted, for example by allowing for the toggle leg 106 to be moved without tools.

According to embodiments, a fourth operating feature 932 may provide for an assembly of a screw 104 and a toggle leg 106 (e.g., the assembly including spring 107 and pivot 108) may be pushed through a baffle of an object (e.g., speaker) to be mounted. According to embodiments, a fifth operating feature 933 may provide for a baffle assembly of an object (e.g., a speaker) to be dropped into a box (e.g., formed of panels) of the object to be mounted. According to embodiments, a sixth operating feature may provide for panels (e.g., of a box, a frame, etc.) of an object (e.g., a speaker) folding around a corner, for example, as provided (e.g., formed, defined, shaped, etc.) by a corner mounting guide assembly as discussed above.

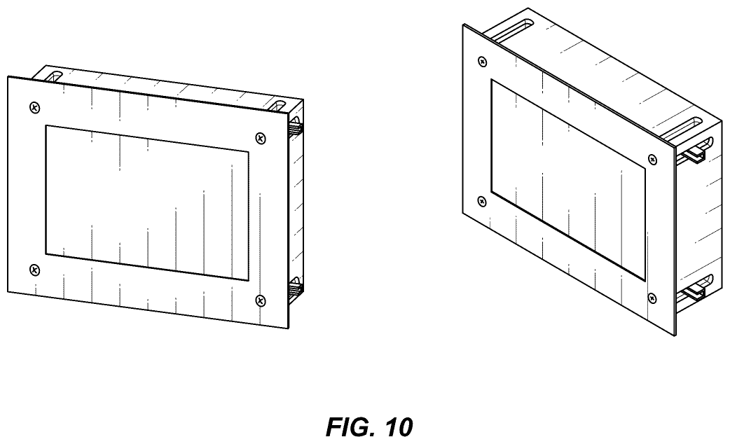

FIG. 10 is a diagram illustrating a display screen mounting assembly, according to embodiments.

According to embodiments, FIG. 10 illustrates a corner mounting guide, for example, according to embodiments discussed above, installed in a mounting assembly for mounting a display screen on to a surface.

While examples of arrangements of devices for performing some examples of the techniques are described herein are given in relation to the Figures, other arrangements may be utilized in some examples. As used herein, the term “couple” and other variations thereof (e.g., “coupled,” “coupling,” etc.) may mean that one element is connected to another element directly or indirectly. For example, if a first element is coupled to a second element, the first element may be connected directly to the second element (without any intervening element, for example) or may be connected to the second element through one or more other elements. A line(s) in one or more of the Figures (e.g., in the block diagrams) may indicate a coupling(s) and/or communication link(s). A coupling may be accomplished with one or more conductors (e.g., one or more wires).

Various configurations are described with reference to the figures, where like reference numbers may indicate functionally similar elements. The systems and methods as generally described and illustrated in the figures herein could be arranged and designed in a wide variety of different configurations. Thus, the following more detailed description of several configurations, as represented in the Figures, is not intended to limit scope, as claimed, but is merely representative of the systems and methods. As used herein, the term “plurality” may indicate two or more. For example, a plurality of components may refer to two or more components.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A corner mounting assembly unit comprising:
a mounting frame including at least: (1) a mounting guide shell formed as one unit;
and having at least two windows on opposing faces and a top opening on a face perpendicular to the two opposing faces, (2) a top plate, and (3) a back plate; and
a retainer having a retention part providing retaining force a more than one position allowed for by the mounting guide shell, the retainer including at least: (1) a screw, (2) a retaining clip, (3) a toggle leg, (4) a spring, and (5) a pivot.

2. The corner mounting assembly unit of claim 1, wherein the mounting guide shell is a molded element fabricated by injection molding.

3. The corner mounting assembly unit of claim 1, wherein the at least two windows are disposed approximately orthogonal to each other.

4. The corner mounting assembly unit of claim 1, wherein the at least two windows have geometries selected from the group consisting of square shapes, rectilinear shapes, oblong shapes, triangular shapes, and elliptical shapes.

5. The corner mounting assembly unit of claim 1, wherein the mounting guide shell includes a curved internal surface configured to allow the toggle leg to freely move between the at least two windows.

6. The corner mounting assembly unit of claim 1, wherein the top plate is formed of steel to provide greater torque resistance before failure.

7. The corner mounting assembly unit of claim 1, wherein the back plate includes an air-sealing bulkhead feature for integration with an enclosed loudspeaker system.

8. The corner mounting assembly unit of claim 1, wherein the screw comprises a head part configured to receive a tool, a neck part, a thread part, and an end part.

9. The corner mounting assembly unit of claim 8, wherein the neck part prevents the toggle leg from traveling beyond a predetermined point before the head part to avoid damage from over-driving.

10. The corner mounting assembly unit of claim 8, wherein the end part includes a break-part for retaining the screw via interaction with molded features in a bottom of the mounting guide shell.

11. The corner mounting assembly unit of claim 1, wherein the retaining clip is disposed in a groove of the screw to prevent the screw from backing out of the mounting guide shell.

12. The corner mounting assembly unit of claim 1, wherein the toggle leg is configured to move between a deployed position extending horizontally relative to a longitudinal axis of the screw and a stowed position aligned approximately parallel to the longitudinal axis of the screw.

13. The corner mounting assembly unit of claim 12, wherein the toggle leg includes a tube feature configured to contact the screw on both sides to relieve force from the pivot.

14. The corner mounting assembly unit of claim 1, wherein the toggle leg is formed of sheet metal having a square tube configuration.

15. The corner mounting assembly unit of claim 1, wherein the spring is a double torsion spring that spans a width of the screw and applies force to the toggle leg causing rotation around the pivot.

16. The corner mounting assembly unit of claim 15, wherein the spring comprises a base part, at least one torsion part having a variable outside diameter, and at least one leg part.

17. The corner mounting assembly unit of claim 15, wherein the torsion spring is tuned to maintain the toggle leg perpendicular to the screw regardless of orientation of a mounted object.

18. The corner mounting assembly unit of claim 1, wherein the pivot includes arms for retaining the pivot to the toggle leg and shoulders for reducing play in the spring.

19. The corner mounting assembly unit of claim 1, wherein the assembly unit is configured to support up to 35 pounds of vertical load per fastener for through-panel installation in drywall substrate.

20. The corner mounting assembly unit of claim 1, wherein the pivot is mounted to the screw and configured to travel along a vertical axis of the screw via threaded engagement.
